(19) United States
(12) Patent Application Publication
(10) Pub. No.: US 2003/0074933 A1
(43) Pub. Date: Apr. 24, 2003

(54) Bicycle lock in the saddle post

(76) Inventor: Rino ST. Amand, Heredia (CR)

Correspondence Address: Andrus Sceales Starke & Sawall, Suite 1100, 100 East Wisconsin Avenue, Milwaukee, WI, 53202-4178, US

(21) Appl. No.: 10/258,276

(22) PCT Filed: Sep. 11, 2001
(86) PCT No.: PCT/IB01/01647

(51) Int. Cl. E05B 71/00

(52) U.S. Cl. 70/18; 70/233

(57) ABSTRACT

A bicycle anti-theft device is made out of the saddle post by substituting to the regular hollow tube two massive half-cylinder arms grooved on their flat sides. The master arm is molded in one single piece with the head-like saddle holder, and the secondary one is terminated at its lower end with a full cylinder ring which houses a tubular cam round key lock. These two arms are coupled together on their flat side to reproduce the standard saddle post diameter and house in their inner face to face grooves an extra bar that pivots around the master arm lower end. The constituting parts of the saddle post can be reassembled and locked in a closed circuit that can be used to secure the bicycle (with the two wheels, the saddle and its post) to a metal fence or to a post. To do so, the secondary arm is hooked to the back of the saddle holder, and then the free end of the pivoting bar is introduced and locked between a buffer and a tubular cam lock mechanism in the secondary arm ring end.

### TECHNICAL FIELD

The technical field to which the invention pertains is the Bicycle Anti-Theft Devices.

### BACKGROUND ART

For bicycles there are two species of locks: the flexible and the rigid types. The flexible type (chain or cable) is usually hooked to or rolled up around the frame, but it can also be hidden, for example in the handlebar. In both cases they don't offer a very high security because they don't resist to the cutter's jaws. The rigid type, usually resistant to metal cutters and saws, offers a better protection and can be added to the bicycle as an accessory (hooked with a bracket), or integrated to the frame, front fork, or whatever part of the bicycle. The accessory one is usually encumbering and has an anti-sportive look Most bicycles don't have the required space inside the frame triangle to house both a bottle holder and a 30 cm U-lock, which is the most common rigid lock. And when installed out of the frame triangle, it's still more obstructive. The integrated lock usually solves both the encumbering problem and the anti-sportive look, but requires the bicycle manufacturers to invest in new equipment and split their assembly methods in order to offer this interesting option. A bicycle lock made out of the saddle post would solve this manufacturing problem along with all the others, but my researches at the U.S. and European Patent Offices seems to indicate that it has not been done up to now. Finally, none of the locks available can secure in one single bite with the frame, the two wheels and the saddle (with its post) which are easily removable on most good quality bikes, just by turning a hand-lever. Consequently, when bikers want to leave their bikes locked outdoors they usually have to decide whether they take the risk to get their saddle stolen or bring it with them.

### DISCLOSURE OF INVENTION

As it is suggested by its name, my invention is in giving a lock function to a bicycle saddle post. Its different parts can be assembled (and locked) together in such a way to form a standard size cylindrical saddle post (FIG. 1). It can also be reassembled to close and lock a triangular circuit that can be used to secure the bicycle frame and the two wheels around a post of up to 55 mm diameter (FIGS. 2 and 3). Instead of having the saddle post made with the usual hollow tube, it uses two massive half-cylinder arms, facing each other to form a full cylinder of the same size (27 mm) as the regular post. The master arm (1) is molded in one single piece with the standard head-like saddle holder (3) at its upper end, and a full cylinder ring (4) terminates the secondary arm (2) at its lower end, which houses a tubular cam round key lock (5). Both arms have a central canal (6) in their inner flat side, facing each other and designed to lodge (when used as a saddle post) a crossbar (7) that pivots around a cross pin (8) at the lower end of the master arm canal. These facing canals are calibrated to approximately share the full cylinder material (and strength) in three equal parts (FIG. 8), which are the master and secondary arms, plus the pivoting crossbar that has the size to fill up the gap left by the twin canals. This crossbar, of which the free end can be locked up between the master arm buffer (9) and the rotating locker disk (10) in the upper part of the secondary arm cylindrical end, is meant to be the third side of a triangular circuit (when used as a bicycle lock). The locking operation is actually performed by key turning the locker disk until its side barrier (11) gets in the crossbar edge cavity (12). At its other end, the same crossbar has an extending knob (13) that prevents it to open wider than necessary (between 150 and 160 degrees angle with the master arm), and also permits to lock both arms one against the other in its post assembly. When opening the crossbar at its widest angle, the extending knob is actually bumping against the end of the master arm canal bottom (14), and when key locking the assembly in its post combination, the locker disk side barrier does hang up behind the extending knob (FIG. 9).

The saddle holder (3) has the same width and curved top radius as the standard one, so the hardware (not shown in the drawings) needed to fix, adjust and constrain the saddle to it stays the same. Besides the one intended for the saddle fastening screw (20), three extra holes have been made in it, which have the following functions. The underneath hole (15) is intended to enter and house the secondary arm hooked end (16), and prevent it from slipping down along the master arm (FIG. 6), when the different parts are assembled as a saddle post. The back hole (17) is designed to attach the secondary arm hook end, when assembling the different parts into a bicycle lock. The transversal hole (18) is only meant to take off material (and weight) where it's not, or almost not participating to the strength of the object Finally, the saddle holder is designed to slide in its lower part (FIG. 7) a thin and flexible metal blade (19), meant to block the access to the saddle fastening screw, when the assembly is used as a bicycle lock. Indeed, the secondary arm nose (21) actually covers the sliding blade free end, thus blocking its opening, when set up in a triangular circuit (FIG. 2).

Besides all the integrated rigid lock's advantageous, the BICYCLE LOCK IN THE SADDLE POST can grab in one single bite (with its 17 cm opening) the back wheel rim along with the frame tube that goes down from the saddle to the pedals. Of course it also secure the saddle and its post, which becomes the lock device by itself, and the bicycle manufacturers don't have to make any modification in their assembly methods. Moreover, any bicycle owner could change their actual seat post for this new one, and keep it for their new bicycle when changing it, something that is normally impossible with the other integrated rigid locks. And thanks to its double function and a bracket free installation, the only weight added to the bicycle is the difference between the new and the old post weight. Finally, its triangular shape makes it more resistant to deformation in comparison with other locks that has parallel sides, and doing so, it offers more strength with less material (it takes less pressure to change the comer angles of a rectangle, than for a triangle).

### BRIEF DESCRIPTION OF DRAWINGS

FIG. 1: Saddle post's side elevation;

FIG. 2: Locked circuit's side elevation;

FIG. 3: Locked circuit's perspective;

FIG. 4: Saddle post's front elevation;

FIG. 5: Saddle post's back elevation;

FIG. 6: Saddle post's longitudinal section side view;

FIG. 7: Detail of the sliding blade assembly;

FIG. 8: Saddle post's cross-section;

FIG. 9: Detail of the saddle post's locking mechanism;

FIG. 10: Saddle post's longitudinal section back view;

FIG. 11 Exploded back view of the individual parts.

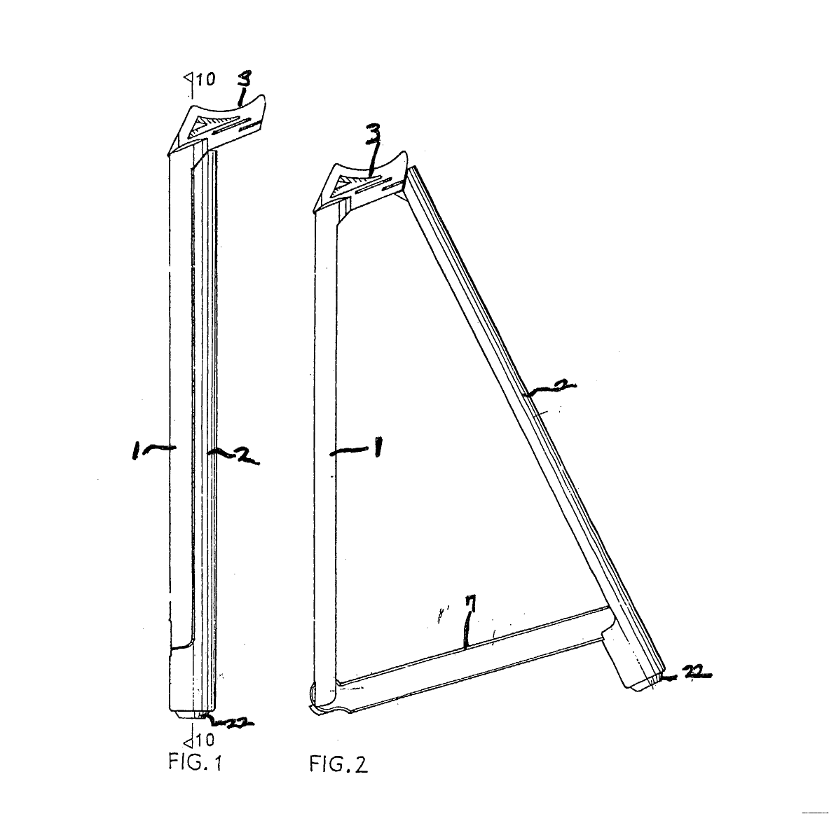

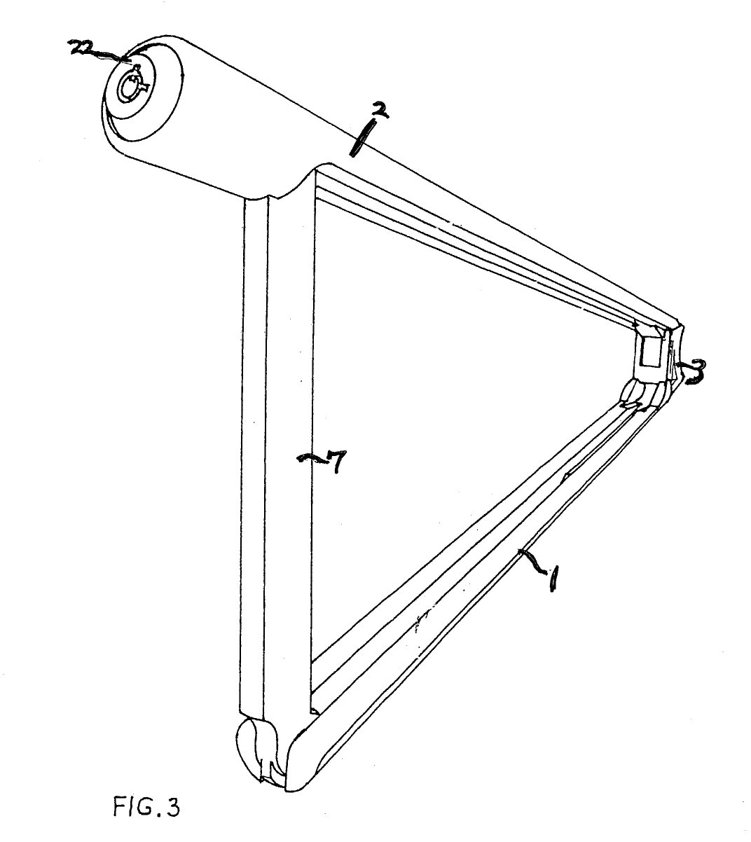

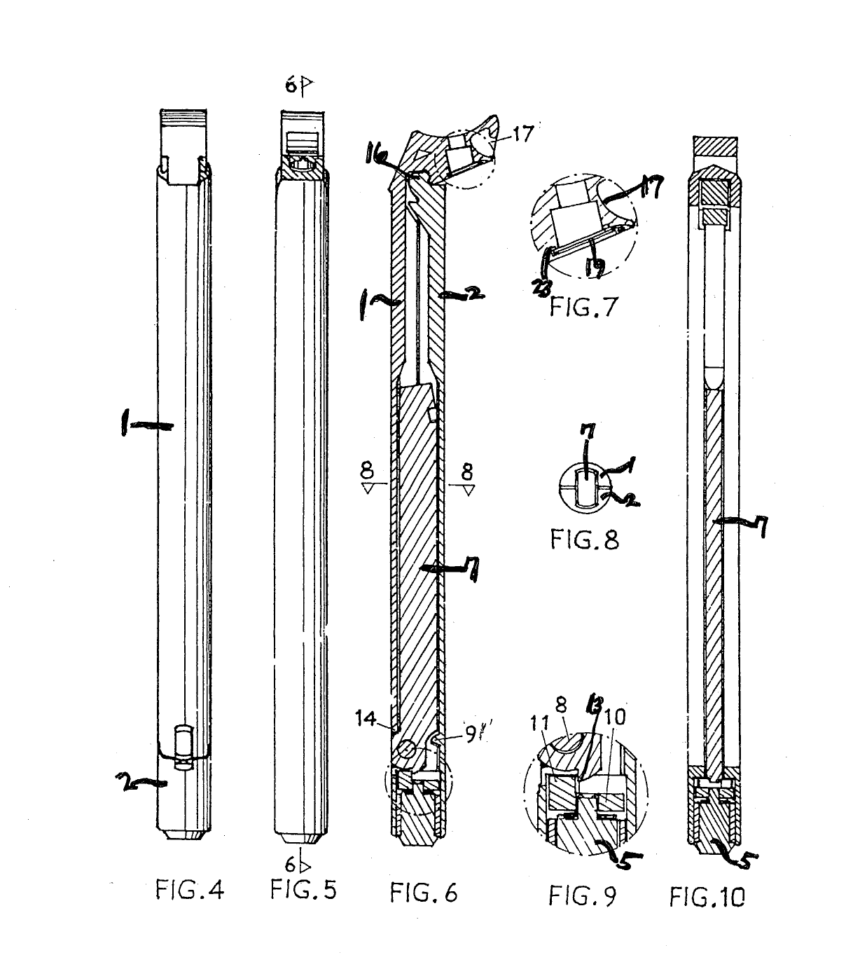

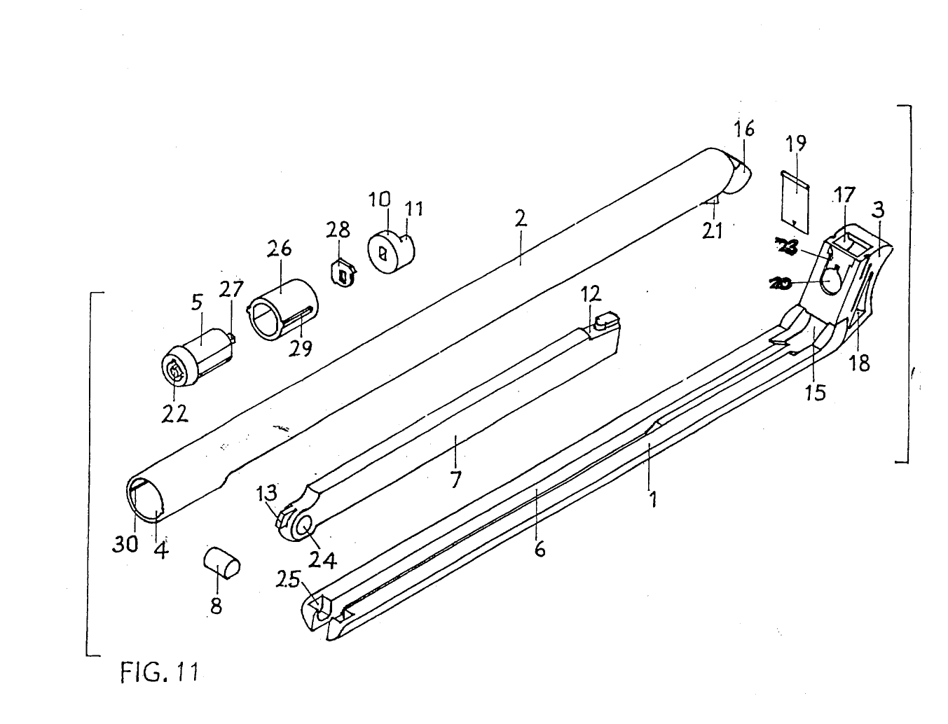

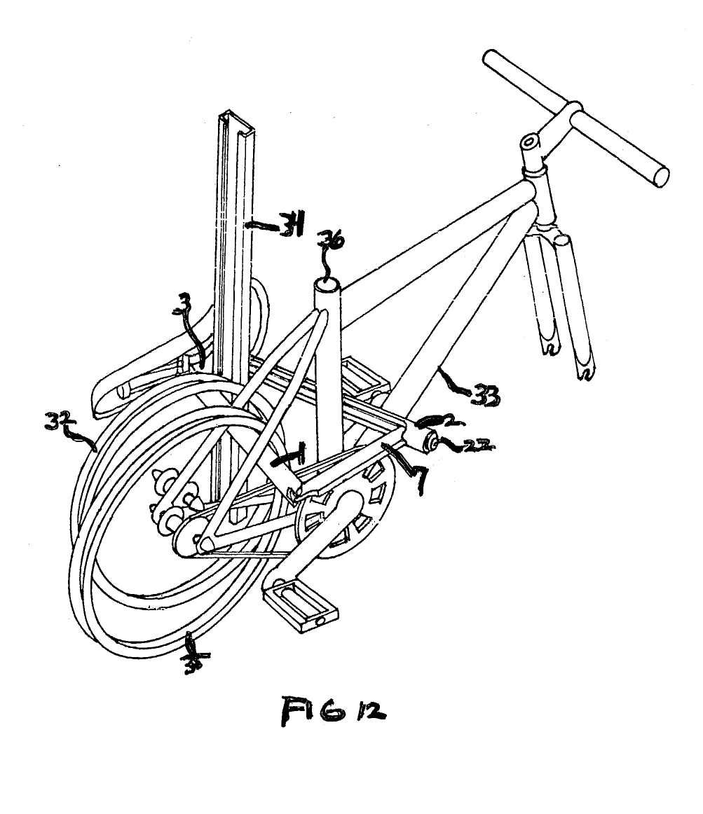

### BEST MODE FOR CARRYING OUT THE INVENTION

Let's suppose that the BICYCLE LOCK IN THE SADDLE POST exists in the real world. I have it on my bicycle, which I want to lock to a street post along the sidewalk. Here's the best way to make use of it. I take off the front wheel and put it between the bike and the street post to which I want to lock it, side by side with the back wheel. I lift up the hand lever to free the Bicycle Lock in the Saddle Post and pull it out of the frame tube. I take out the (round) key from my pocket, insert it in the key receptacle (22) at the lower end of the cylinder post and turn it clockwise—quarter revolution—to free the secondary arm from its blocked position. I pull the secondary arm away from the master arm at its lower end and then take its hook-like end out of the under-head hole. I then put the same hook end in the back-head hole in a rotating movement, starting at a 90-100 degrees angle with the master arm and closing it to its narrowest angle possible, which is the same as when the whole circuit is closed and locked up. I pull the crossbar out of its lodging canal (if it didn't came out by itself up to now) and rotate it up to its widest angle (between 150 and 160 degrees) with the master arm. Then I embrace the street post with one aim on each side of it, passing the crossbar and the master arm inside the frame triangle, 15 cm above the pedals' axle, while on the other side I do the same with the secondary arm across the rays of both wheels. To close the circuit, I open the arms angle just what it needs to next push the free end of the crossbar in the lower end of the secondary arm canal, and then put the key in its receptacle and turn it back to its initial position. The total assembly is now blocked in a triangle circuit and no part of it can move in relation to the others. And there's no way to take off the saddle because the free end of the sliding blade passing over the fastening screw head is now covered by the secondary arm nose and blocked in its closed position (FIG. 2).

Industrial Applicability

With the exception of the sliding blade that would be cut out of a thin flexible metal sheet, and the tubular cam lock (including its washer and key) already available on the market, all the extra parts would be cast in moulds. The cast material would be high resistance steel or whatever actual (or eventual) alloy that can offer a very good resistance to scissors and traction forces, as well as to corrosion. The sliding blade which would be folded at one end and hammer-punched to form its stopper at the other end, would be introduced between the side grooves (23) under the saddle holder and pushed in until its stopper's end gets into the bottom groove. On the other hand to fix the crossbar to the master arm, the cross pin (8) would be first inserted in its (crossbar) hole (24), to next put the assembly in the master arm canal with each end of the cross pin laying down on its flat side in the flat bottom of the cross groove (25). With the cross pin being shorter than the receiving cross groove, it leaves a gap at each end large enough to be filled up by a welding process. It can then be polished to take off the welding overflow if necessary.

The tubular cam lock (5) in the actual prototype have been modified (the threads have been scraped off and the central axle pin cut shorter) and would eventually have to be manufactured this way for the BICYCLE LOCK IN THE SADDLE POST purpose. To assemble it, it's first introduced in the inner ring (26), and then its axle pin (27) passes through the stoppage washer (28) and finally pressured in the locker disk (10) central hole. This partial assembly is then pressured in the secondary arm ring end (4), until the inner ring outer side wedges (29) abut in the bottom of the outer ring inner grooves (30). This leaves just the space needed for the locker disk to rotate freely (without any friction). To prevent the assembly to come out, a welding “drop” can be added at the start of both outer ring inner grooves, or thin cross pins could be pressured across the outer ring and against the tubular cam lock sides (5).

1. What I claim as my invention is the design of a bicycle saddle post, of which the different constituting elements can be re-assembled and locked in a dosed circuit, which can be used to lock the bicycle to a fix object (post, fence, etc). This new saddle post is characterized by the replacement of the usual hollow tube with two massive half-cylinder arms that can house in their inner flat side canals the extra material necessary to close and secure the circuit.
